(19) United States
(12) Patent Application Publication
(10) Pub. No.: US 2019/0053517 A1
(43) Pub. Date: Feb. 21, 2019

(54) Pea Protein Product

(71) Applicant: WORLD FOOD HOLDINGS, LLC, Oskaloosa, I (US)

(72) Inventors: Kushal Narayan Chandak, Minneapolis, MN (US); Tyler John Lorenzen, Minneapolis, MN (US)

(21) Appl. No.: 16/104,670

(22) Filed: Aug. 17, 2018

Related U.S. Application Data
(60) Provisional application No. 62/547,557, filed on Aug. 18, 2017.

(51) Int. Cl. A23J 1/14; A23J 3/22; A23J 3/14; A23L 2/66; A23L 23/00; A23J 3/34

(52) U.S. Cl. CPC A23J 1/148; A23J 3/22; A23J 3/14; A23V 2002/00; A23L 23/00; A23J 3/346; A23L 2/66

(57) ABSTRACT

The present invention relates to a pea protein material that is at least 70% dry weight pea protein, of which at least 20% dry weight protein is soluble in water at ambient temperature, has a pH of about 6-8 and has a viscosity of about 12-20 units according to Test A. Preferably, the pea protein material of this invention additionally has a viscosity of about 12-65 units according to Test B. Preferably, the pea protein material meets USDA Organic Certification requirements. Preferably, the pea protein material meets Non-GMO Project Verified requirements.

### CROSS-REFERENCE TO RELATED APPLICATIONS

This application claims the benefit of U.S. Provisional Patent Application No. 62/547,557, filed Aug. 18, 2017, entitled “Pea Protein Product”, which is hereby incorporated by reference in its entirety.

### BACKGROUND OF THE INVENTION

The present invention is broadly concerned with a protein material that can be used to make nutritious, palatable, high protein content, high moisture food products without using allergen protein sources (e.g., soy, milk, gluten). In particular, but not exclusively, the present invention is concerned with a pea protein material that can be used in high quantities in food products with high water content, including but not limited to beverages and sauces.

The present invention includes a method for making this protein material that involves solubilizing and separating pea protein from ground, de-hulled peas and then precipitating the pea protein in a form that has unique functional characteristics useful for use in high water content food products. The resultant pea protein material can then be used to make high water content food products with a smooth mouthfeel, a creamy mouthfeel, and an overall viscosity that is desired by consumers in high water content food products that are stable to refrigerated and freeze/thaw conditions.

The role of pea protein in finished consumer products varies with each type of finished food product. Pea proteins can have several functions in finished food products, including emulsification, foam stability, sedimentation stability (i.e., precipitation, suspension), and body (e.g., viscosity, thickness). Pea proteins also effect finished food product taste, aroma, and color. Commonly used protein sources include wheat (e.g., gluten), animals (e.g., gelatin), and animal by-products (e.g., egg albumin, milk casein, milk whey). In high water content food products such as sauces (e.g., gravies and sweet sauces) and beverages (e.g., milks and RTD drinks) the proteins most commonly used are egg and milk proteins (e.g., whey, casein). Beverages cover a wide range of finished consumer food products, including but not limited to milks (e.g., dairy and non-dairy), sports/nutritional drinks, aseptic packed drinks, acidified hot-fill packed drinks, and fruit juice or fruit flavored drinks. Beverages can be carbonated or non-carbonated. Beverages can be produced such that they are to be stored at ambient, refrigerated, or frozen temperatures. Manufactures usually label their products with directions to store the beverages at refrigerated temperatures once the package has been opened. Sauces cover a wide range of finished consumer food products, including by not limited to gravies, white sauces, fruit based sauces (e.g., sweet and sour sauces), fermented product bases (e.g., soy sauces, teriyaki sauces, oyster sauces), and tomato based sauces (e.g., barbeque sauces, spaghetti sauces). Sauces could be processed by retort, aseptic, acidified food, or kettle cook. Some sauces are sold as a part of entrees (e.g., gravy on meat patties), which are stored frozen and then heated by consumers. Sauce products are usually labeled to be stored at refrigerated temperatures once opened. An ideal beverage and sauce would maintain its texture during ambient and refrigerated storage as well as be stable to freeze/thaw temperature cycles.

Consumer trends have shown a growing interest and belief in the need for increased protein in their diets, especially proteins that are not gluten based, milk based, or animal based. Celiac disease is an autoimmune disorder that affects roughly 1% of the American population. Gluten intolerance is the cause of this disease. Persons who have celiac disease have various stomach complaints when they consume wheat based products due to their immune system attacking the tissue of their bowels. Many consumers who do not specifically have celiac disease still believe that avoiding gluten protein in their diets allows them to have better digestive health. Lactose intolerance is the difficulty in digesting lactose that is naturally found in milk. Many consumers are born lactose intolerant (e.g., unable to digest lactose) and many consumers lose the ability to digest lactose as adults. The result of this lactose intolerance is intestinal discomfort. The experience is uncomfortable enough that consumers with lactose intolerance are concerned and cautious in consuming products with any milk based protein products in fear of any trace lactose present in those milk based protein products. Due to the health effects of these proteins, FDA categorizes these proteins as allergenic ingredients (e.g., allergens) and they must be listed on labels.

Consumers on vegan diets are interested in avoiding finished food products that contain animal based proteins, which include proteins from egg, meat, and milk sources. The avoidance of gelatin containing products can also be attributed by religious dietary laws.

Extensive research and product development has been done to create finished consumer products with soybean based proteins used as replacements for wheat, milk, and/or animal based proteins. As FDA categorizes these soybean proteins as allergenic ingredients, they too must be listed on labels. Many consumers do not like the beany flavor unique to soybean products.

Peas are not allergens, do not cause digestive problems, and have little if any flavor. Pea proteins have been used in many consumer products as protein alternatives for gluten, animal, milk, and soybean based proteins.

Consumers have a growing interest in food products formulated with a high protein content. One such product line is nutritional beverages, also called sports drinks. Often these high protein drinks are consumed as a meal replacement, thus the manufacturer's interest in a protein ingredient that can be used at high concentrations in high water content food products.

Pea proteins can be used in a large range of food products to add thickness and to control moisture (e.g., by water absorption and water solubility), but the amount of traditionally produced pea protein material that can be added to a formulation is limited due to the high water absorption of pea protein. Manufacturers would prefer to be able to add more pea protein to their products, while maintaining the consumer expected finished product viscosity and creamy mouthfeel.

Therefore, there is a need for an alternative protein product that has an acceptable texture and is not wheat based, milk based, animal based, or soy bean based. This alternative protein product must have the functional characteristics necessary to meet the needs of manufacturers and consumers.

Therefore, there is a need for a pea protein material with adjusted physical characteristics that would allow the pea protein material to have the water absorption and water solubility properties necessary to allow a high level of protein addition to create a consumer expected thickness and creamy mouthfeel texture in the final high water content food products, even under refrigeration and freeze/thaw cycle storage conditions.

### SUMMARY OF INVENTION

The present invention relates to a pea protein material that is at least 70% dry weight pea protein, of which at least 20% dry weight protein is soluble in water at ambient temperature, has a pH of about 6-8 and has a viscosity of about 12-20 units according to Test A. Preferably, the pea protein material of this invention additionally has a viscosity of about 12-65 units according to Test B. Preferably, the pea protein material meets USDA Organic Certification requirements. Preferably, the pea protein material meets Non-GMO Project Verified requirements. Non-GMO Project is a nonprofit organization offering a third-party Non-GMO verification program as currently disclosed at www.nongmoproject.com.

### DETAILED DESCRIPTION OF INVENTION

The pea protein material of this invention includes material that is at least 70% dry weight pea protein, of which 20% dry weight protein is soluble in ambient temperature water, has a pH of about 6-8 and has a viscosity of about 12-20 units according to Test A. Preferably, the pea protein material of this invention additionally has a viscosity of about 12-65 units according to Test B. Also preferably, the pea protein material meets USDA Organic Certification requirements. Preferably, the pea protein material meets Non-GMO Project Verified requirements. Non-GMO Project is a nonprofit organization offering a third-party Non-GMO verification program as currently disclosed at www.nongmoproject.com.

The process of this invention is a method of manufacturing the pea protein material of this invention with physical characteristics that give it unique functional characteristics that make it useful in creating high moisture food products with the appearance, viscosity, and mouthfeel characteristics desired by consumers. This process is not limited by the number of process steps, or the order in which they are performed.

The product of this invention contains a pea protein. As used herein, “pea” means the mostly small spherical seed of the pod fruit Pisum sativum. In particular, the pea used in this invention is from varieties of the species typically called field peas or yellow peas that are grown to produce dry peas that are shelled from the mature pod. Peas have been harvested as human food as far back as the early third century BC. Peas are traditional foods in the diets of people living on every continent, most particularly in European, Asian, North Africa, and North American countries. Though traditionally a cool-season crop, new varieties have been bred that can be grown in hotter climates and also in dryer climates. Peas also have been bred to contain higher and higher contents of protein. These breeding practices, as well as the cultural eating histories of so many people, make peas an excellent source for protein for many consumers world-wide.

All percentages are in dry weight, unless specified otherwise as total weight. High water content foods are edible products (i.e. human or animal food) containing greater than 20% total weight water. High protein content foods contain greater than 4% dry weight protein. As a comparison cow's milk contains 3-4% total weight protein.

The pea protein material of this invention includes at least 70% dry weight protein, preferably at least 80% dry weight. Peas as traditionally harvested and dried, have a hull portion (about 6-10% dry weight of whole pea) and a seed portion (about 90-94% dry weight of whole pea). When the hull is removed, the seed portion has a content of up to about 12-15% total weight moisture, about 50-60% total weight starch, about 2-4% total weight fat, about 10-30% total weight protein. The product of this invention is not limited by the specific protein content of the peas used in the production of the pea protein material of this invention. A large number of pea varieties are available to the producer and each has its own protein content percentage. Preferably, the pea varieties used to produce the pea protein material of this invention meets Non-GMO project verified requirements and as such are naturally breed and not genetically created or bioengineered. Preferably, the pea varieties used to produce the pea protein material of this invention are Organic Certified by USDA regulations.

Non-GMO means not genetically modified. FDA.gov website currently includes guidance for manufactures who wish to voluntarily label food as containing or not-containing genetically engineered ingredients. Additional labeling regulations as to mandatory labeling of foods containing genetically engineered ingredients are being developed for enforcement starting roughly 2020. Under these regulations, traditional breeding of pea plants would be free of genetically engineered ingredients and bioengineered ingredients.

Organic Certified means that the source of the ingredients and the finished food product have been produced according to specific requirements wherein the pea plants would only come in contact with organically approved herbicides, pesticides, process aids and cleaning materials.

Creamy mouthfeel means that the product has a smooth and non-gritty feel in the mouth, while also having some thickness that coats the tongue and mouth surfaces. Gritty (also called grainy) mouthfeel means that the tongue and/or mouth surfaces can feel tiny particles. Creamy appearance means that the product appears smooth, homogeneous, and yet flows. Gritty (or mealy) appearance means that the product appears rough, heterogeneous, and yet flows. Sedimentation and separation appearance means that the product appears to be in layers, usually one layer darker or more opaque than another layer. Thickness means that the product moves when force is applied. The thicker (more viscous) the product is, the more force is needed to move the product. A product that moves when the container it is in is tipped to the side is called pourable. For example, beverages are pourable and sauces are usually pourable.

The pea protein material of this invention has a pH of 6-8 (at 10-30% total weight concentration in water at ambient temperatures [i.e., 72-77 F]). Pea protein (as traditionally grown, harvested, and ground) has an isoelectric point of about pH 4.5. The isoelectric point is the pH at which particular molecule carries no net electrical the statistical mean. This means that the pea proteins (which are mostly globulins) have a minimum solubility near the isoelectric point of pH 4.5 and a high solubility above and a moderate solubility below pH 4.5.

Proteins are made up of a bundle of molecules of different lengths, each molecule having charges and reactive points along their lengths. This charged and reactive state is what allows proteins to absorb water and to be water soluble. As protein is not charged at its isoelectric point of pH 4.5, protein is least reactive with water at pH 4.5. The inventors discovered a process that allows the water absorption and water solubility of pea protein to be altered such that the pea proteins in the inventive pea protein material have the water solubility and water absorption properties ideal to give the inventive pea protein material the unique functions of limited thickening and high water solubility which leads to thickening, creamy appearance, and creamy mouthfeel, while also acting as sedimentation stabilizers initially and after cycling through several temperature ranges.

Using creative processing conditions, the inventors have discovered that the pH of pea proteins can be adjusted to the pH 6-8, which then allows the pea proteins to remain soluble during and after processing of high water content food products (e.g., beverages, sauces). As a comparison, cow's milk is typically pH 6.4-6.8. Acidic hot-fill Ready-To-Drink beverages are usually less than pH 4.4. The creative processing conditions of the invention also put the protein in a charged and reactive state that allows the amount of thickening power most useful in formulations of high water content food products. That is, high levels of protein can be added to food products without objectionably high product thickening.

The pea protein material of this invention is produced under processing conditions that give the pea protein material a pH range of about 6-8. The processing conditions used to adjust the pH of the pea protein material can be done by various methods known in the art, including the addition of acid and/or base during separating of the protein from the fiber and starch portions, or addition of acid and/or base after the separation of the protein from the fiber and starch portions, or addition of acid and/or base after reduction of water from the protein portion of the starting ground pea material. What is key is that the pH is adjusted to that which gives the final pea protein material its required functional characteristics.

The protein in peas comprises many individual proteins of various molecular weights. Though the majority of the proteins are globulins, even they are of a range of molecular weight molecules. To make pea protein more soluble, it can be treated in such a way as to break some of those protein molecules into smaller molecules (i.e., smaller molecules having smaller molecular weights), exposing more charged and reactive sites for interaction with water molecules. This is commonly called hydrolyzing the protein. The resulting hydrolyzed proteins are commonly called protein hydrolysates.

The process for producing the pea protein material of this invention contains two steps: 1) creating a pea protein intermediate slurry containing at least 70% dry weight protein; and 2) treating the pea protein intermediate slurry so as to create the unique at least partially hydrolyzed pea protein material.

Producing an at least 70% dry weight protein pea protein intermediate slurry from peas can be done by several different processes known by those who practice in this art. The specific method chosen does not limit the scope of this invention. In general, the process includes reducing the pea into particles that can then be separated into fiber, starch, and protein portions. One method of such separation is to grind the dry pea, and use a series of air classification steps to remove the lighter weight fiber and starch, and to leave behind an intermediate pea protein material that has at least 70% dry weight protein content. A second method of separation is to grind the pea so as to only remove the hull, then grind the remaining pea material with enough water to create an intermediate stage slurry, and finally separate out the insoluble fiber and starch portions from the intermediate stage slurry to create a pea protein intermediate slurry containing the soluble protein portion. Separation of pea protein from the intermediate stage slurry in this second method can be done using various separation techniques. These techniques include, but are not limited to, decanters, centrifuges, clarifiers, and hydro cyclones. The pea protein intermediate slurry containing at least 70% dry weight protein can be formed by removing water through various separation techniques including, but not limited to, decanters, centrifuges, clarifiers, ovens, spray dryers, fluid bed dryers, and drum dryers.

There are more than one way of breaking the protein molecules into smaller molecules (i.e., hydrolyzing the protein). One way is by using acid to cleave bonds in the protein molecule structure. This method can damage the proteins, which could actually become less soluble. By products are often created with bitter, or other otherwise unpleasant flavors.

The inventors discovered a more efficient and effective way of reducing the size of the pea protein molecules: hydrolysis with enzymes under certain temperature and time conditions. Hydrolysis makes the resulting pea protein more soluble, but too much hydrolysis reduces its usefulness as a thickener in high moisture products. Too much hydrolysis can also make the protein less water soluble. The problem the inventors solved was to create a unique process using pH and enzyme hydrolysis to create the inventive pea protein material that has the unique ability to remain soluble and to thicken to an acceptable level for use in making high water content food products with the thickness, appearance, creamy mouthfeel, and temperature stability desired by manufacturers and consumer.

In an embodiment of this invention, an at least 70% dry weight protein pea protein intermediate slurry is made by the second method already described. The pea protein is then separated from the intermediate slurry by adjusting the slurry to the pea protein's isoelectric point causing the protein to coagulate. The coagulated protein is then removed from the bulk of the intermediate slurry and the pH of the coagulated protein is adjusted to about pH 5-8, using a food grade buffer, including but not limited to calcium hydroxide, potassium hydroxide, sodium hydroxide, and combinations thereof. Endo-protease, exo-protease, or combinations thereof are added to the neutralized pea protein so as to cleave some of the protein molecular bonds. Enzymes used could include, but are not limited to, chymotrypsin, bromelain, fugal protease, aspartic acid protease, ficain enzyme, bacterial protease, papain, or combinations thereof.

Temperature and time during the hydrolysis and after hydrolysis processing of the pea protein material is important toward creating the pea protein material with the functional characteristics of the current invention. In an embodiment of this invention the temperature of the process used to reduce the molecular weight of the protein molecules must be about 90-200 F, preferably about 100-180 F, most preferably 120-150 F for about 5-120 minutes, preferably 10-70 minutes, most preferably 20-60 minutes. The inventors found that conditions outside these ranges could create too little cleavage or too much cleavage of the bonds in the pea protein, which would affect the functional characteristics of the resulting pea protein material. Also, the greater the cleavage, the greater the chance of the creation of free amino acids that could create bitter flavors in the resulting pea protein material. To end the cleavage activity of the enzymes, the pea protein material is heated to over 250 F. The pea protein material can then be left liquid or, as preferred, reduced to less than about 15% water content.

The water reduction process used is not limited for the production of the pea protein material of this invention, and can include, but is not limited to, spray drying, fluid bed drying, oven drying, drum drying, vacuum drying and freeze drying. The preferred method of drying the pea protein material is spray drying using an inlet slurry temperature of about 100-250 F to dry the pea protein material at about 200-600 F.

In an embodiment of this invention the pea protein material of this invention is used in making food products wherein some part of the food product production process includes the making of a high water content intermediate product.

In an embodiment of this invention the pea protein material of this invention is used in a beverage, preferably at greater than about 1, 5, 10, 12, 15, 20, 25, 3, or 40% total weight of the beverage, most preferably at 1, 5, 10, 12, 15, 20, 25, 30, or 40% dry weight of the beverage.

In an embodiment of this invention the term sauce includes, but is not limited to gravies, sweet and sour sauces, fermented base sauces (e.g. oyster sauce, soy sauce, teriyaki sauces), broths, tomato based sauces, soups, and white sauces.

In an embodiment of this invention the pea protein material of this invention is used in a sauce, preferably at greater than about 1, 5, 10, 12, 15, 20, 25, 30, or 40% total weight of the sauce, most preferably at 1, 5, 10, 12, 15, 20, 25, 30, or 40% dry weight of the sauce.

In an embodiment of this invention, sauces and beverages include with the pea protein material of this invention bulking ingredients, as well as flavoring ingredients. Bulking ingredients to be included in the sauces and/or beverages include, but are not limited to starches, fibers, other proteins, hydrocolloids, and celluloses. Bulking ingredients refers to ingredients that provide mass and structure. Flavoring ingredients to be included in the sauces and/or beverages include, but are not limited to sweeteners, acids, salts, fruit based ingredients, spices, and flavors.

In an embodiment of this invention the pea protein material of this invention is used in making food products wherein some part of the food product production process includes the making of a high water content intermediate product.

In an embodiment of the invention, the process of reducing the pea protein molecular weight is completed using enzymes including, papain, bromelain, fungal protease, or combinations thereof.

In an embodiment of the invention, the process of reducing the pea protein molecular weight with enzymes is done at a temperature range of 90-200 F, most preferably at 110-150 F.

In an embodiment of the invention, the process of reducing the pea protein molecular weight with enzymes is done by heating the pea protein material for 5-120 minutes, preferably for 10-70 minutes, most preferably for 12-60 minutes.

In an embodiment of the invention, the pea protein material of this invention may be used in any food product, including but not limited to extruded snacks, bakery product, confectionery products, meat or meat-replacement products, cheese or cheese-like products, beverages, and sauces.

In embodiments of this invention, pea protein material with the thickening and creaminess functional characteristics of this invention are used to make beverages and sauces that contain thickening and creaminess characteristics.

In embodiments of this invention, beverages include pea protein which is partially hydrolyzed such that the finished beverages have creamy mouthfeel and thickness.

In embodiments of this invention, sauces included pea protein which is partially hydrolyzed such that the finished sauces have creamy mouthfeel and thickness.

In embodiments of this invention, beverages include pea protein that is texture stable under refrigerated and freeze/thaw conditions.

In embodiments of this invention, sauces include pea protein that is texture stable under refrigerated and freeze/thaw conditions.

### EXAMPLES

A pea protein material example, in accordance with the present invention was produced that had about 80-86% dry weight pea protein, of which 15-25% dry weight protein was soluble in water at ambient temperature and had a pH of about 6-8. The pea protein material was non-GMO. The pea protein material was produced by grinding de-hulled peas with water, creating a slurry with water, separating insoluble fiber and starch using centrifugation, coagulating soluble protein, separating out the coagulated protein and adjusting the pH to about 6-8 by adding a food grade buffer, partially hydrolyzing the protein with proteases, and then heating and drying the resulting pea protein material to about 12-14% water content.

Table 1 compares the characteristics of the above produced pea protein material (sample B), to a pea protein sample produced without enzymatic hydrolyzation (sample A), and to a pea protein sample produced with more enzymatic hydrolyzation (sample C). All three samples were similarly produced except as to the enzyme hydrolyzation step. All samples were commercial products of PURIS (Oskaloosa IA): P870 (sample A); P870MV (sample B); P870H (sample C).

TABLE 1
Pea Protein Samples: A B, and C Evaluation Data

| | Molecular | | | |
|---|---|---|---|---|
| | weight % > | | | |
| | 50K | Units | Units | Sensory Evaluation: |
| | Daltons per | per Test | per | Mouthfeel and |
| Example # | Test X | A | Test B | Thickness |
| No-H(A) | 68% | 9.3 | 79 | Very thick and had dense |
| | | | | top layer; and smooth |
| | | | | mouthfeel and appearance. |
| Some-H(B) | 67% | 16.5 | 17 | Thick, creamy mouthfeel |
| | | | | and appearance. |
| More-H(C) | 77% | >24 | 6 | Very thin and separated; |
| | | | | some grittiness. |

Test X (the molecular weight measurements) was completed according to the following procedures (testing completed by Medallion Laboratories, Golden Valley, Minn. according to their standard procedure): “Protein Molecular Weight Distribution by Superose 6 Gel Filtration Chromatography” [Protein Molecular Weight Method Reference: Andrews, J.,(1965) Biochem, J. 96:595-606]

Explanation of the molecular weight results: There are many methods for measuring protein molecular weights, and each method can create artifacts in the results. The amount of hydrolyzation in each sample was tested in the above described SDS method. The unhydrolyzed pea protein sample (A) had a higher percent of larger molecular weight protein molecules than the other two samples. The more hydrolyzed pea protein sample (C) had the smallest percent of larger molecular weight protein molecules of the three samples. The third sample (B) would be assumed to have a percentage of larger molecular weight proteins between that of the other two samples, and it did.

All protein molecular testing methods have data artifacts created by the testing method. A testing artifact of this SDS method could be the interaction between the charged SDS gel material and the charged protein molecules. Also, the fluid used to carry the samples to and through the SDS gel could possibly affect the charge of both the SDS gel and the protein samples. For this reason, all three samples were evaluated using the same SDS gel material, as well as the same sample preparation methods. So the effects of the described SDS method on the data measurements were assumed to be similar across all samples. Assuming that, the molecular weight data does show logical differences between the samples that can be at least partially explained by the pea protein production processes used (i.e., more and less hydrolyzation). But the differences in molecular weight percentages between the three samples is not very large, and so molecular weight data does not completely explain the broad variation in functional characteristics between the three samples, much less the unexpected functional characteristics of the less hydrolyzed pea protein sample (B). More on this will be covered in later discussion.

The functional characteristic measured in Test A was viscosity. In Test A, each of the pea protein samples (A, B, C) were made into 17% solutions with water, which were heated to about 180 F in a pan on a stove top and held heated for about 3-5 minutes, and then cooled to room temperature. Samples were then stored in covered containers at refrigerated temperatures for roughly 18 hours before being brought back to room temperature for viscosity testing. To test the sample viscosity, the sample compartment of a consistometer (part number 24925-000, supplied by CSC Scientific Company, Inc., Fairfax, Va., USA) was filled with sample material, and then the distance down the consistometer ramp was recorded 5 seconds after the sample guillotine was raised. Each sample (A, B, C) were tested under the same consistometer conditions (i.e., the same consistometer geometry and the ramp at maximum height of 3 cm). The viscosity units according to Test A were the number of centimeters the sample moved along the consistometer ramp.

As the test data illustrates, the viscosity of the samples became much less (i.e., units per Test A were much more) as the amount of protein hydrolyzatiom increased. The differences in viscosity between the samples, though, is much greater than what would be expected based on the molecular weight data.

The functional characteristic measured in Test B was viscosity. In Test B, each of the pea protein samples (A, B, C) were made into 17% solutions with water as described under Test A, including returning the samples to room temperature after roughly 18 hours in the refrigerator. A tall sample cup holding roughly 150 ml of sample was prepared, a Spindle C was inserted two centimeters below the sample surface, the speed was set at 12, and the number of units was read off of the Brookfield dial after running (rotating) for 30 seconds. The units of viscosity via Test B was recorded as the number of units read off of the Brookfield dial. The Brookfield was LV design with dial reading.

As the test data illustrates, the viscosity of the samples became much less (i.e., units per Test B were much more) as the amount of protein hydrolyzation decreased. The differences in viscosity between the samples, though, is much greater than what would be expected based on the molecular weight data.

The functional characteristic measured in the Sensory Test C was appearance and mouthfeel. The three samples were evaluated at room temperature for appearance when stirred in a cup with a spoon and evaluated in the mouth. As illustrated in the results given in Table 1, the sample with the greatest thickness was the unhydrolyzed pea protein sample (A) and the thinnest was the more hydrolyzed pea protein sample (C). Sample B fell between the other two samples in thickness and perceived creaminess. Unexpectedly, the smoothest, most creamy mouth feel in the mouth was sample B.

TABLE 2
Pea Protein Samples: Sensory Test D Results

| Example # | Graininess (i.e., Grittiness) | Smoothness |
|---|---|---|
| No-H (D) | 21 | 147 |
| Some-H(E) | 16 | 124 |
| More-H(H) | 87 | 75 |

The functional characteristic measured/evaluated in the Sensory Test D was mouthfeel. In the Sensory Test D, three pea protein samples (No hydrolyzation:D; Some hydrolyzation:E; More hydrolyzation:F) were made into 10% solutions with water, and heated to about 180 F for about 1-2 minutes and then cooled to room temperature and sensory tested the same day. Seven people evaluated the samples blind and in random order, and then marked a 155 cm line labeled “none” at 0 cm and “very much” at 155 cm. as to their perceptions of amount of smoothness and graininess in the mouth. Graininess is the same as grittiness. All samples were commercial products of PURIS (Oskaloosa Iowa): P870 (sample D); P870MV (sample E); P870H (sample F). The sample B was the pea protein material of this invention.

The data shows that hydrolyzation can affect the perceived smoothness and graininess of a pea protein material. The pea protein material (sample E) of this invention had the least perceived graininess indicating good protein solubility. Even the nonhydrolyzed material (sample D) had more perceived graininess than sample E. The pea protein material (sample E) of this invention had a high perceived smoothness score, which was higher than the score for the more hydrolyzed sample (sample F).

TABLE 3
Pea Protein Samples: Sensory Test E Results:

| | Appearance: | Appearance: | Appearance: | Mouthfeel: |
|---|---|---|---|---|
| Sample | Separation | Thickness | Smoothness | Creaminess |
| No-H (A) Day 1: | Denser top, floating | Very thick, top | Smooth | Creamy |
| | layer; sample was | layer very thick, | | |
| | chunky when tried to | did not move | | |
| | mix in top layer | when tipped | | |
| No-H (A) Day 2: R | Denser top layer | Same as Day 1 | Smooth | Creamy |
| | formed (then some top | | | |
| | layer accidently | | | |
| | removed*) | | | |
| No-H (A) Day 2: | Same separation, | Same as R Day 2 | Smooth | Creamy |
| F/T | mixes together | | | |
| No-H (A) Day 3: R | Some separation, | Same as R Day 2 | Smooth | Creamy |
| | mixes together | | | |
| No-H (A) Day 3: | Looks like cracked | Looks like | Looks like | Slippery on |
| F/T | along (freezing) lines | cracked on frozen | curdled | tongue, some |
| | after thawing | lines when | mayo, | creamy |
| | | thawed, did not | | |
| | | move when | | |
| | | tipped; thicker | | |
| | | than R Day 2 | | |
| Some-H (B) Day 1 | No Separation | Thick, moved | Smooth | Creamy |
| | | when tipped | | |
| Some-H (B) Day | No separation | Thick, moved | Smooth | Creamy |
| 2: R | | when tipped, a | | |
| | | little thicker than | | |
| | | Day 1 | | |
| Some-H (B) Day | No Separation | Thick, moved | Slightly | Creamy with |
| 2: F/T | | when tipped, a | chunky, | slight grainy |
| | | little thicker than | mixes out | and chunky |
| | | Day 1 | | |
| Some-H (B) Day | No Separation | Thick, moved | Smooth | Creamy |
| 3: R | | when tipped, a | | |
| | | little thicker than | | |
| | | Day 1 | | |
| Some-H (B) Day | No Separation | Slightly thicker | Smooth | Creamy |
| 3: F/T | | than R Day 2 | | |
| Some-H (B) Day | No Separation | Thick, moved | Smooth | Smooth |
| 7: R | | when tipped, a | | |
| | | little thicker than | | |
| | | Day 1 | | |
| Some-H (B) Day | No Separation | Thick, moved | Smooth | Creamy |
| 21: R | | when tipped, a | | |
| | | little thicker than | | |
| | | Day 1 | | |
| More-H (C) Day 1: | Separated, denser and | Very thin | Smooth | Creamy with |
| | more opaque on | | | some |
| | bottom | | | grittiness |
| More-H (C) Day 2: | Some separation, | Very thin | Smooth | Creamy with |
| R | mixes together | | | some |
| | | | | grittiness |
| More-H (C) Day 2: | Some separation, | Very thin | Smooth | Creamy with |
| F/T | mixes together | | | some |
| | | | | grittiness |
| More-H (C) Day 3: | Some separation, | Very thin | Smooth | Creamy with |
| R | mixes together | | | some |
| | | | | grittiness |
| More-H (C) Day 3: | Separated, looks like | Very thin | Slight | Less creamy, |
| F/T | opaque flakes | | chunky with | more mealy |
| | submerged in | | flakes | and some |
| | translucent liquid | | | grittiness |
| More-H (C) Day 7: | Separated and looks | Very thin | Curdled | Less creamy |
| R | curdled | | appearance, | than R Day 3 |
| | | | but mixed | |
| | | | together | |
| More-H (C) Day | Separated with denser | Very thin | Curdled | Less creamy |
| 21: R | bottom | | appearance, | than R Day 3 |
| | | | but mixed | |
| | | | together | |

Wherein “R” Means Refrigerated Storage and “F/T” Means Frozen then Thawed.

The functional characteristic evaluated in the Sensory Test E was appearance of separation; appearance of thickness; appearance of smoothness; and mouthfeel of creaminess. In the Sensory Test E, samples were made and evaluated at room temperature on Day 1. Then a sub set of samples of each of several pea protein samples (A, B, C) were refrigerated for 24 hours, brought to room temperature and evaluate (Day 2). Another sub set of samples were frozen and then thawed and brought to room temperature and evaluated (Day 2). Both sub sets of samples were put through another refrigerated storage or freeze/thaw cycle and evaluated (Day 3). Sample B and C continued their refrigerated storage and were evaluated on Day 7 and Day 21.

As illustrated in the results in Table 3, though the unhydrolyzed pea protein sample (A) was thicker after refrigeration and freeze/thawing, it did not appear to keep a constant thickness, appearance, or mouthfeel like that of the pea protein material produced by the methods of the invention (sample B). The most hydrolyzed pea protein sample (C) was the thinnest to start with, and refrigeration and freeze/thawing made the samples appear to become even thinner, more separated, and less creamy.

Overall, the pea protein material of this invention, which was produced by the method of this invention, performed better in a high water content format than did the more hydrolyzed and the not hydrolyzed pea protein samples. The pea protein material of this invention was able to be used to create a thick but pourable (i.e., moved when sample was tipped) viscosity that was more stable to refrigerated storage and freeze/thaw cycling than the not hydrolyzed pea protein sample and the more hydrolyzed pea protein sample.

The compositions and methods of the present invention are capable of being incorporated in the form of a variety of embodiments, only a few of which have been illustrated and described. The invention may be embodied in other forms without departing from its spirit or essential characteristics. The described embodiments are to be considered in all respects only as illustrative and not restrictive, and the scope of the invention, therefore, is indicated by the appended claims rather than by the foregoing description. All changes which come within the meaning and range of equivalency of the claims are to be embraced within their scope.

What is claimed is:

1. A pea protein material comprising:
a) at least 70% dry weight pea protein;
b) at least 20% dry weight of the pea protein is soluble at room temperature at pH 6 -8; and
c) the pea protein material has a viscosity of about 12-20 units according to Test A.

2. The pea protein material of claim 1, wherein the pea protein material has a pH of about 6-8.

3. The pea protein material of claim 1, wherein at least 60% of the protein has a molecular weight greater than 50,000 Daltons according to Test X.

4. The pea protein material of claim 1, wherein the pea protein material has a viscosity of about 12-65 units according to Test B.

5. The pea protein material of claim 1, wherein the pea protein material meets USDA Organic Certification.

6. The pea protein material of claim 1, wherein the pea protein material meets Non-GMO project verified requirements.

7. The process of making a pea protein material of claim 1, wherein the pea protein product is made using enzymes to reduce at least some of the pea proteins into smaller molecular weights.

8. The process of making a pea protein material of claim 1, wherein the process includes the steps of:
a) grinding de-hulled dry peas;
b) mixing the ground peas with water to make a slurry;
c) separating the fiber and starch portions from the protein portions to make an intermediate protein slurry, d) coagulating the protein in the intermediate protein slurry, e) neutralizing the coagulated protein in the intermediate protein slurry, f) intermixing the neutralized intermediate protein slurry with enzyme, g) heating the neutralized intermediate protein slurry containing enzyme to about 90-200 F for 5-120 minutes;
h) removing water from the heated neutralized intermediate protein slurry to make a finished pea protein material.

9. The process of claim 8, wherein the enzyme used is selected from the group consisting of bromelain, chymotrypsin, ficain enzyme, papain, and combinations thereof.

10. The process of claim 8, wherein the heating is from 100-180 F.

11. The process of claim 8, wherein the heating is for 10-70 min.

12. A beverage product containing the pea protein material of claim 1, wherein the beverage product is selected from the group including milks, sports drinks, nutritional beverages, fruit based beverages, carbonated beverages, non-carbonated beverages, non-dairy beverages, acidified hot-fill beverages, Ready-To-Drink beverages, retorted beverages, aseptic packed beverages and combinations thereof.

13. A sauce product containing the pea protein material of any one of claim 1.

14. A sauce product containing the pea protein material of any one of claim 1, wherein the sauce is selected from the group consisting of gravies, sweet and sour sauces, fermented base sauces (e.g., oyster sauce, soy sauce, teriyaki sauces), broths, tomato based sauces, soups, white sauces, and combinations thereof.

15. A pea protein material comprising:
a) at least 70% dry weight pea protein; and
b) at least 20% dry weight of the pea protein is soluble at room temperature at pH 6-8, wherein the pea protein material has a viscosity of about 12-65 units according to Test B.

16. A pea protein material of claim 15, wherein the pea protein material is used to create a creamy pourable textured product.

17. A pea protein material of claim 15 wherein the pea protein material is used to stabilize a food product against water separation or protein coagulation during refrigerate storage.

18. A pea protein material of claim 15, wherein the pea protein material is used to stabilize a food product against water separation or protein coagulation during freeze/thaw storage cycling.

19. A high water content food, comprising at least 1-40% dry weight pea protein material of claim 1.

20. A high water content food, comprising at least 1-40% dry weight pea protein material produced by process of claim 8, wherein the food does not contain any soybean protein, gluten, egg, albumin, milk protein, or gelatin.
